(19) United States
(12) Patent Application Publication
(10) Pub. No.: US 2026/0337801 A1
(43) Pub. Date: Oct. 29, 2026

(54) PRODUCTION OF HYDROGEN AND LITHIUM HYDROXIDE IN A BASIC ENVIRONMENT

(71) Applicant: Evonik Operations GmbH, Essen (DE)

(72) Inventors: Christian Hying, Rhede (DE); Elisabeth Gorman, Haltern am See (DE); Patrik Stenner, Hanau (DE); Sabrina Juretzka, Frankfurt am Main (DE); Tobias Stadtmüller, Seligenstadt (DE); Sebastian Arndt, Ginsheim Gustavsburg (DE); Frank Löffler, Heppenheim (DE); Huong Klink-Tran, Mannheim (DE); Jessica Antoni, Nidderau (DE); Nicole Decker, Bochum (DE); Meike Dahlhues, Marl (DE)

(21) Appl. No.: 19/110,769

(22) PCT Filed: Sep. 1, 2023
(86) PCT No.: PCT/EP2023/073983

§ 371 Date: Mar. 11, 2025

(30) Foreign Application Priority Data
Sep. 12, 2022 (EP) 22195067.8

(51) Int. Cl. C25B 15/031; C25B 1/04; C25B 1/16; C25B 9/23

(52) U.S. Cl. CPC C25B 15/031; C25B 1/04; C25B 1/16; C25B 9/23

(57) ABSTRACT

The present invention relates to the electrochemical production of hydrogen and lithium hydroxide from Li+-containing water using a LiSICon membrane. The problem addressed by the present invention is that of specifying a process which is operable economically even on an industrial scale. The process shall especially exhibit a high energy efficiency and achieve a long service life of the membrane even when the employed feed contains impurities harmful to LiSICon materials. A particular aspect of the process is that the cell simultaneously separates off the lithium via the membrane and effects electrolysis of water. An essential aspect of the process is that the electrochemical process is performed in a basic environment, more precisely at pH 9 to 13. The pH is adjusted by addition of a basic compound to the feed.

For the production of lithium-ion batteries (LIBs), lithium (Li) is by definition necessary. On account of its high reactivity, lithium occurs in nature not as the pure substance, but always in bound form. The starting material used for the production of LIBs is generally lithium in the form of lithium hydroxide (LiOH) or lithium carbonate (Li₂CO₃).

In most natural deposits Li is present in the form of lithium oxide (Li₂O) or salts such as lithium sulfate (Li₂SO₄) or lithium chloride (LiCl). Lithium oxide is a constituent of ores such as pegmatite, while lithium sulfate and lithium chloride are present in dissolved form in the leach liquors of Li salt lakes. In the course of the mining process, the lithium compound extracted in the particular case is converted into lithium carbonate (Li₂CO₃). In a further process step, the lithium carbonate can be converted into lithium hydroxide by reaction with quicklime or calcium hydroxide. The extraction of Li and its transformation into LiOH is described in:
Wietelmann, U. and Steinbild, M. (2014). Lithium and Lithium Compounds. In Ullmann's Encyclopedia of Industrial Chemistry, (ed.). DOI: 10.1002/14356007.a15_393.pub2

Rich Li deposits are known, but the production of LiOH from the Li compounds they contain is very energy intensive and generates large volumes of wastewater. There is also a strategic need to be free of dependency on the owners of the deposits.

One solution to this problem could be to reprocess the materials from spent LIBs so that the lithium contained therein can be reused as a raw material for new batteries.

Recycling processes for LIBs have already in the past been developed to industrial maturity, but were in most cases aimed at the metals Fe, Ni, Mn, Co, Mg and Al present therein. The alkali metal Li was not generally recovered, since its high reactivity makes it difficult to separate from scrap batteries and it was available at low cost in sufficient amount from natural deposits. The extraction of Li from used LIBs for a long time seemed simply uneconomical.

However, there is now growing social and economic pressure to recover lithium from used LIBs. In order for this idea to come to fruition, it is necessary for recycled Li to be supplied to producers of LIBs in an acceptable quality such that the manufacturing processes for LIBs from recycled Li do not differ from those using mined virgin Li. It goes without saying that there must be no adverse effect on battery quality. Recycled Li, especially in the form of LiOH, must consequently meet very stringent specifications as regards purity. In addition, the process for recovering Li from old batteries must be as energy-efficient as possible. The process should also use little water.

Known processes for recovering lithium from old batteries are collated in:
Pankaj K. Choubey et al.: Advance review on the exploitation of the prominent energy-storage element Lithium. Part II: From sea water and spent lithium ion batteries (LIBs), Minerals Engineering, volume 110, 2017, pages 104-121 DOI: 10.1016/j.mineng. 2017.04.008.

A technology that is mentioned only in passing as “LISM” in the above review article is the electrolysis of Li-containing waters in the presence of what are known as LiSICon membranes.

LiSICon stands for lithium super ionic conductor. This is a class of inorganic glass-ceramic materials that are electrical insulators, but at the same time have an intrinsic conductivity for Li ions. The transport mechanism for Li derives from the crystal structure of the material. The Li ions are—in simplified terms—“passed through” the crystals. Commercially available LiSICon materials include lithium aluminium titanium phosphate (LATP), lithium aluminium titanium silicon phosphate (LATSP), lithium aluminium germanium phosphate (LAGP) and lithium lanthanum titanium oxide (LLTO). These materials were originally developed as solid-state electrolytes for LIBs. An overview of the transport mechanisms of LiSICons, their crystal structure and production is given in:
Palakkathodi Kammampata et al.: Cruising in ceramics-discovering new structures for all-solid-state batteries—fundamentals, materials, and performances. Ionics 24, 639-660 (2018) DOI: 10.1007/s11581-017-2372-7
Yedukondalu Meesala et al.: Recent Advancements in Li-Ion Conductors for All-Solid-State Li-Ion Batteries. ACS Energy Lett. 2017, 2, 12, 2734-2751 DOI: 10.1021/acsenergylett.7b00849

Specific LiSICon stoichiometries are described by:
Sofia Saffirio et al. Li_{1.4}Al_{0.4}Ge_{0.4}Ti_{1.4}(PO₄)₃ promising NASICON-structured glass-ceramic electrolyte for all-solid-state Li-based batteries: Unravelling the effect of diboron trioxide, Journal of the European Ceramic Society, volume 42, issue 3, 2022, pages 1023-1032 DOI 10.1016/j.jeurceramsoc.2021.11.014.
Eongyu Yi et al. Materials that can replace liquid electrolytes in Li batteries: Superionic conductivities in Li_{1.7}Al_{0.3}Ti_{1.7}Si_{0.4}P_{2.6}O₁₂. Processing combustion synthesized nanopowders to free standing thin films. Journal of Power Sources, volume 269, 2014, pages 577-588, DOI 10.1016/j.jpowsour.2014.07.029.

Their selective conductivity for Li ions means that LiSICon materials can be used as a membrane for separating Li from Li-containing mixtures. The Li must be present in the mixture in ionic form, for instance as an Li salt dissolved in water. The driving force that is needed to push the Li ions through the LiSICon membrane is an electrical voltage. An electrochemical cell comprising two electrodes and an LiSICon membrane that divides the cells into two compartments is constructed for this purpose. In each compartment there is an electrode. The compartments are referred to as anodic or cathodic depending on the polarity of the electrode present in the respective compartment. An electrical voltage is applied to the electrodes and the anionic compartment is filled with the Li-containing water. The cathodic compartment is filled with water. The membrane passes the Li cations through to the cathode. The water in the cathodic compartment therefore becomes enriched with Li, while the water on the anodic side becomes depleted in Li. Such a process is termed membrane electrolysis.

Membrane electrolysis processes for extracting lithium with the aid of LiSICon membranes have already been described in the prior art.

For instance, Zhen Li et al. describe a process in which the weakly lithium-containing water of the Red Sea is used as a raw material:
Zhen Li et al.: Continuous electrical pumping membrane process for seawater lithium mining. Energy Environ. Sci., 2021, 14, 3152 DOI: 10.1039/d1ee00354b

The Zhen Li research group use LLTO as the membrane. The target product that is separated off is lithium phosphate (Li₃PO₄), which is suitable for the production of lithium iron phosphate (LFP) batteries. LIBs having a different cathode material, for example nickel-manganese-cobalt (NMC) or lithium manganese oxide (NMO), cannot be directly produced therewith

Yang et al. have sought to extract metallic lithium directly from seawater with the aid of solar power, an LAGP membrane and a copper foil.
Sixie Yang et al.: Lithium Metal Extraction from Seawater. Joule, volume 2, issue 9, 2018, pages 1648-1651, DOI 10.1016/j.joule.2018.07.006.

US 2016/0201163 A1 describes the separation of Li ions from a brine such as seawater with the aid of LiSICon membranes. Proposed membrane materials are specifically Li₃N, Li₁₀GeP₂S₁₂, LaₓLi_{y}TiO₂, and Li_{1+x+y}Alₓ(Ti, Ge)₂₋ₓSi_{y}P_{3-y}O₁₂. The target product is lithium carbonate (Li₂CO₃).

WO 2019055730 A1 is likewise concerned with the separation of lithium with the aid of LiSICon membranes. LLTO, LAGP and LATP are specifically mentioned. The LiSICon material can be applied to a support structure. The chemical nature of the support structure is not described in detail. Similarly little is described as to how the application of the LiSICon to the support structure is to be effected. The separated target product is Li ions.

U.S. Pat. No. 9,222,148B2 also discloses the separation of lithium hydroxide by membrane electrolysis on an LiSICon membrane and consequent precipitation of lithium hydroxide hydrate.

In addition to the use of ceramic LiSICon membranes, electrolytic processes for the separation of lithium that operate with organic ion-exchange membranes have also been disclosed.

For instance, EP 3805428 A1 describes the electrolytic production of lithium hydroxide. As well as the electrolysis, an electrochemical conversion of the lithium into lithium hydroxide is operated. To obtain the necessary reactants, water undergoes a simultaneous electrochemical splitting. This is done using a bipolar three-compartment cell with an ion-exchange membrane. The commercially available Asahi® AVV, Nafion® 902, Fumatech® FAB, Fumatech® FKB and Neosepta® CMB ion-exchange membranes are used. The chemical nature of these ion-exchange membranes is not disclosed in EP 3805428 A1, but they will in all likelihood be organic membrane materials. The three-compartment cell operates in acidic media. Used as the feed is water containing Li salts such as lithium sulfate (Li₂SO₄) or lithium chloride (LiCl) in particular.

A two-stage electrodialytic/electrolytic production of lithium hydroxide from aqueous lithium sulfate and/or lithium bisulfate with simultaneous water splitting is disclosed in U.S. Pat. No. 10,036,094 B2. The first stage employs an electrochemical cell having two compartments and the second stage a three-compartment cell. The prevailing pH in the three-compartment cell can be from 8 to 10. The cells are equipped with ion-exchange membranes. The chemical composition of the ion-exchange membranes is not given. The following commercial membranes are mentioned: Fumatech® FAB, Astom® ACM, Asahi® MV, Nafion® 324 and Astom® AHA.

A fundamental drawback of polymer membranes is their permeability to water. This results in dilution of the anolyte with water from the catholyte. In addition, organic ion-exchange membranes are less ion-selective than inorganic LiSICon materials. They allow not just Li⁺, but also Na⁺ to pass through, thereby lowering the purity of the target product when Na is also present in the feed. As well as the purity of the target product, the electricity efficiency of the process also suffers: If the electrolysis is carried out using a non-ion-selective membrane, the transport of unwanted Na⁺ to the second compartment will also consume valuable electrical energy. Moreover, on reaching the second compartment the Na⁺ will be converted into unwanted by-products by means of unintended electrochemical processes. The energy efficiency of the process based on the yield of the target product Li is reduced. Lastly, these membranes are sensitive to the presence of divalent cations such as Mg²⁺ and Ca²⁺. Over time these cations poison the membrane, thereby limiting the service life of organic ion-exchange membranes.

The glass-ceramic LiSICon materials promise better ion selectivity. However, the stability of the LiSICon membranes to impurities continues to be a highly significant problem for industrial practice here. For instance, the Li⁺-containing water generated in the reprocessing of used LIBs contains other cations such as Na⁺ and K⁺ in particular, which cause lasting damage to the LiSICon material: These cations appear to occupy the defects in the crystal structure, thereby bringing transport of the Li⁺ cations through the membrane to a virtual standstill. The service life of the electrochemical cell is then expired. The high cost of the LiSICon material means that recycling of Li from LIBs is uneconomical if the service life of the membrane is short. Also, the brine from Li salt lakes has a naturally high sodium content and therefore cannot be allowed to come into contact with known LiSICon membranes. Lithium from salt lakes therefore additionally undergoes an energy-intensive thermal separation and/or a stepwise process using large volumes of water in which it is dissolved and then recrystallized. Although the water can here be evaporated by solar radiation, the water to dissolve the LiCl is scarce in the deserts of South America. This route is thus highly problematic there.

Another practical problem is the high specific electrical resistance of the LiSICon material. This results in the electrochemical cell having a high ohmic internal resistance, which means that the process has a correspondingly high electrical energy requirement. To lower the, the membrane can in theory be made thinner. However, the low thickness of the material would in turn afford it only a short lifetime in aggressive environments.

Based on all the above, the problem addressed by the present invention is that of specifying a process for the electrochemical production of LiOH from Lit-containing water with the aid of an LiSICon membrane that can be operated economically on an industrial scale too. In particular, the process should have good energy efficiency and achieve a high membrane lifetime even when the employed feed contains impurities that are harmful to LiSICon materials.

This problem is solved by a process according to claim 1.

The invention accordingly firstly provides a process for producing hydrogen and lithium hydroxide, comprising the following steps:
a) providing a feed comprising at least water, Li cations, anions, and also impurities, the concentration of Li cations in the feed C_{F} being at least 200 ppm by weight or between 500 ppm by weight and 140 000 ppm by weight, in each case based on the total weight of the feed, the pH of the feed measured at 25 °C using a glass electrode being between 2 and 9;
b) providing a poor working medium comprising water and lithium hydroxide dissolved therein, the concentration of lithium hydroxide in the poor working medium C_{M0}, based on the total weight of the poor working medium, being at least 50 ppm by weight;
c) providing a basic compound;
d) providing at least one electrochemical cell, wherein the electrochemical cell has the following properties:
   i. the electrochemical cell includes a first compartment in which an anode is arranged;
   ii. the electrochemical cell includes a second compartment in which a cathode is arranged;
   iii. the electrochemical cell includes a membrane that separates the first membrane from the second membrane, the membrane having the area A;
   iv. the membrane comprises an inorganic material that possesses conductivity for Li ions and that is electrically insulating;
e) providing at least one electrical voltage source that is connected to the anode via a first electrical lead and to the cathode via a second electrical lead;
f) metering the basic compound into the feed such that an intermediate is obtained, the pH of the intermediate measured at 25 °C using a glass electrode being between 9 and 13;
g) charging of the first compartment with the intermediate;
h) charging of the second compartment with the poor working medium;
i) charging of the electrochemical cell with an electrical voltage U drawn from the electrical voltage source such that an electrical current/flows between the anode and cathode, the ratio Q of the current strength of the electrical current/and the area A of the membrane being between 100 A/m² and 500 A/m² or between 150 A/m² and 350 A/m²;
j) withdrawing from the first compartment of wastewater comprising at least water, Li salts dissolved therein, oxygen and also impurities, the concentration of Li ions in the wastewater C_{W}, based on the total weight of the wastewater, being lower than the concentration of Li ions in the feed C_{F};
k) withdrawing from the second compartment of a rich working medium comprising water and lithium hydroxide and also hydrogen, the concentration of lithium hydroxide in the rich working medium C_{M1}, based on the total weight of the rich working medium, being greater than the concentration of lithium hydroxide in the poor working medium C_{M0}.

A particular aspect of the process according to the invention is that the selective separation of lithium by the membrane and an electrolysis of water take place simultaneously in the cell. In the water electrolysis, water (H₂O) is split electrochemically into H₂ and O₂. At the cathode, OH⁻ and hydrogen are formed. The OH⁻ anions are however unable to cross the LiSICon membrane and combine with the Li⁺ cations arriving in the cathodic compartment to form lithium hydroxide LiOH. At the anode, oxygen and H⁺ are formed.

The simultaneous operation of the Li⁺ membrane separation and the water electrolysis in the electrochemical cell with LiSICon membrane thus results in the direct formation of lithium hydroxide LiOH and molecular hydrogen H₂. LiOH is dissolved in water, H₂ to a small extent too, but is mostly expelled in gas form. The water containing the LiOH and the dissolved and gaseous H₂ are withdrawn from the cathodic compartment. The LiOH is separated from the water. This makes it possible to extract an LiOH that—because of the selective migration of lithium ions through the membrane—has a purity sufficient for it to be used in battery production.

The hydrogen that is simultaneously evolved can be collected and used in the hydrogen economy. If the electrochemical cell is operated with green electricity, the process also leaves a small CO₂ footprint.

The feed needed for the combined Li separation and water electrolysis is a water containing Li⁺ cations. Such water is either generated during the reprocessing of used LIBs or else an Li brine from a natural deposit is used.

A key aspect of the process according to the invention is that the electrochemical process is carried out in basic media, more precisely at pH 9 to 13. This permits an efficient water electrolysis, which is in turn the precondition for the direct production of LiOH. Furthermore, preliminary long-term studies indicate that LiSICon materials have a particularly long lifetime in this pH range, even at high current densities.

The prevailing pH is preferably between 9 and 13 both in the first compartment and in the second compartment. The pH in the two cells can be the same or it can be different, provided it is in both cases between 9 and 13. This is because examination of the half-cell reactions of the water decomposition has shown that the combination of an anolyte cell operated with an acidic feed with a catholyte cell operated with a basic working medium requires a higher voltage for the water decomposition than the combination of two half-cells each having a basic feed. A basic pH in both half-cells (compartments) is thus particularly advantageous, since it requires a lower voltage for the same processes. Compared with a process in which an acidic pH is present in the anolytic compartment while a basic pH prevails in the cathodic compartment, the energy saving afforded by the reduction in voltage when there is a basic process in both compartments is in the region of approx. 5% to 15%, depending on the chosen voltage level for the membrane process.

Since the lithium-containing material streams from battery recycling or seawater are not usually basic, but instead tend to be acidic (pH 4 to 9), the pH is according to the invention adjusted by adding a basic compound to the feed. Only the resulting intermediate having the desired pH of 9 to 13 is fed into the cell. The pH values are specified for temperatures of 25 °C. The pH is measured using a glass electrode calibrated with a commercially available test liquid.

The cathodic compartment is according to the invention charged with a working medium. This is water having a variable concentration of LiOH. In the inflow to the second compartment, the LiOH concentration c_{M0} is at least 50 ppm by weight. In the outflow, the LiOH concentration c_{M1} is much higher. The inflow is therefore referred to as “poor working medium”, while the outflow is termed “rich working medium”. The attributes “poor” and “rich” relate to the LiOH content. The lower limit for the LiOH content in the poor working medium of c_{M0}>50 ppm by weight must be conformed to in order that the process can be initiated with a low electrical resistance in the working medium: The desired production of LiOH and H₂ has been found to proceed much less successfully when the second compartment is charged with water that is free of LiOH. There is no specific upper limit for the LiOH concentration in the poor working medium. However, it must be the case that C_{M0}<C_{M1}, since otherwise the process does not produce any LiOH. The 50 ppm by weight of LiOH is equivalent to 15 ppm by weight of lithium.

A further key aspect of the process according to the invention is the high current density with which it is operated. To be specific, the current density, i.e. the ratio Q of the current strength of the electrical current I and the area A of the membrane, is between 100 A/m² and 500 A/m², or preferably between 150 A/m² and 350 A/m²; These high current densities permit high electricity efficiency, but they also require the membrane material to show good stability under harsh conditions. The chosen membrane material is therefore an inorganic material that is electrically insulating and at the same time conductive for Li ions. Examples of suitable membrane materials are glass-ceramic LiSICons.

The basic compound used to adjust the pH of the intermediate is preferably one of the following substances or mixtures: calcium hydroxide (Ca(OH)₂), potassium hydroxide (KOH), sodium hydroxide (NaOH), lithium hydroxide (LiOH) and ammonium hydroxide (NH₄OH). These substances are preferably used in the form of aqueous solutions, in other words potassium hydroxide solution, sodium hydroxide solution, lithium hydroxide solution or aqueous ammonia. Such aqueous solutions are easy to meter in. Potassium hydroxide solution and sodium hydroxide solution are relatively inexpensive. Lithium hydroxide solution is preferably itself produced in the process.

Very particular preference is given to using Ca(OH)₂ as the basic compound. Calcium hydroxide is used especially in its hydrated form, i.e. as slaked lime. Slaked lime is readily obtainable. The advantage of slaked lime over potassium hydroxide solution and sodium hydroxide solution is that it contains virtually no K or Na. This means that the intermediate does not become contaminated with the membrane poisons K⁺ and Na⁺.

The basic compound is optimally metered into the feed such that the pH of the intermediate, measured using a glass electrode at 25 °C, is between 9 and 12. In this pH window the water splitting operates very well and the membrane is not attacked. The glass electrode for determining the pH should be calibrated in the standard manner using a defined test liquid.

The electrochemical cell can also be operated at temperatures other than 25 °C. The pH should not be adjusted: The intermediate should at the cell temperature have a pH corresponding to a pH of 9 to 12 at 25 °C. The cell temperature may be 20 °C to 70 °C.

The addition of the basic compound has the additional advantage that undesired ions present in the feed become bound. The membrane is thereby protected and the purity of the product improved. More particularly, the addition of the basic compound makes it possible to work with a feed that contains one or more of the following anions: sulfate, carbonate, hydroxide, chloride and fluoride.

With this set-up it is possible that in aqueous solutions the anions are present in equilibrium with the corresponding protonated ions. The precise concentrations depend here on the exact pH of the respective solution and can be calculated with the aid of the corresponding acid and base constants. The calculation is shown in:
Ruland (ed.) et al.: Analytik: Daten, Formeln, Übungsaufgaben [Analytics: data, formulae, exercises], edition 109, 2019, Walter de Gruyter GmbH & Co. KG pages 257ff.

In addition to the anions mentioned, the feed may also contain impurities in the form of compounds of the following elements: B, Na, Mg, Al, Si, K, Ca, Mn, Fe, Co, Ni, Cu, C. The listed alkali metals and alkaline earth metals are elements found alongside lithium in natural deposits, while the other metals mentioned are used as conductive or cathode materials in LIBs and are consequently present in feeds obtained from the reprocessing of used LIBs. The carbon originates from organic compounds that had been present in LIBs, for instance from films, separators, sealants or adhesives. According to the invention, a membrane is used that includes an inorganic material. The required ion selectivity is thus achieved differently than in the case of polymer membranes. The membrane preferably consists entirely of the inorganic material. Composite membranes that contain the inorganic material solely as a coating on a support material or in which the inorganic material is dispersed in a matrix material of a different type have proved the wrong approach.

In order for the process to work, the inorganic material must conduct Li ions and at the same time act as an electrical insulator.

The specific conductivity o for Li ions should of a temperature of 23 °C be at least 1*10⁻⁵ S/m or at least 5*10⁻⁵ S/m or at least 10*10⁻⁵ S/m and not more than 100*10⁻⁵ S/m. The Li conductivity of the material is measured by impedance spectroscopy. This measurement takes place as follows:

The measurement set-up comprises two cylindrical electrodes, with the sample arranged therebetween. To ensure optimal contact with the electrodes and reproducible contact pressure, a weight is placed on the sample.

A potentiostat (Zahner-Elektrik I. Zahner-Schiller GmbH & Co. KG, Kronach-Gundelsdorf, Germany) is connected to the electrodes and controlled via the Thales software (Zahner). The measurements are carried out in a frequency range from 1 Hz to 4 MHz and at an amplitude of 5 mV using samples that had been polished and sputtered onto a thin conductive gold layer.

The results of the measurements are presented in the form of Nyquist plots and evaluated using the analysis software (Zahner). The electrical resistance is read at the maximum of the curve of the Nyquist plot. The specific ion conductivity σ [mS/cm] is then calculated using the formula σ=(h·10⁴)/(R·π/4·d²), where h is the height of the sample in mm, R the measured electrical resistance in Ω and d the diameter of the sample in mm.

The specific conductivity for electrons y (electrical conductivity) should at a temperature of 23 °C be less than 10⁻⁷ S/cm (10⁻⁹ S/m) or less than 10⁻¹² S/m or less than 10⁻¹⁶ S/m. From an electron conducting point of view, the inorganic material is therefore classified as a non-conductor.

Preference is given to using an LiSICon as the inorganic material. LiSICon materials are glass-ceramic substances that conduct lithium ions and at the same time act as electrical insulators. All known LiSICon materials can in principle be used as the inorganic material for the purposes of the invention. Known LiSICon materials meet the requirements specified above both for the electrical conductivity and for the ion conductivity of the inorganic material.

For example, the LiSICon material lithium aluminium titanium phosphate (LATP) may be used. Accordingly, in one variant of the invention the inorganic material is a compound of the following stoichiometry:

Li₁₊ₓAlₓTi₂₋ₓ(PO₄)₃

where 0.1≤x≤0.3, where preferably x=0.3.

Alternatively, the LiSICon material lithium aluminium germanium phosphate (LAGP) may be used. Accordingly, in one variant of the invention the inorganic material is a compound of the following stoichiometry:

Li₁₊ₓAlₓGe₂₋ₓ(PO₄)₃

where: x=0 or x=0.2 or x=0.4.

Alternatively, the LiSICon material lithium aluminium titanium silicon phosphate (LATSP) may be used. Accordingly, in one variant of the invention the inorganic material is a compound of the following stoichiometry:

Li_{1+x+y}AlₓTi₂₋ₓSi_{y}P_{3-y}O₁₂

where 0.1≤x≤0.3 and 0.2≤y≤0.4.

As an alternative to the phosphates mentioned, the oxidic LiSICon material lithium lanthanum titanium oxide (LLTO) may be used. Accordingly, in one variant of the invention the inorganic material is a compound of the following stoichiometry:

Li₃ₓLa_{(2/3)-x□(1/3)-2x}TiO₃

where 0≤x≤0.16.

Particular preference is however given to using an LiSICon that is derived from lithium aluminium germanium phosphate but additionally contains titanium. This is referred to as an LAGTP.

Accordingly, in a preferred variant of the invention the inorganic material is a compound of the following stoichiometry:

Li_{1.4}Al_{0.4}(Ge₁₋ₓTiₓ)_{1.6}(PO₄)₃

where 0≤x≤1.

In a particularly preferred development of the invention, an LATSP that additionally contains germanium is used. This is termed an LAGTSP.

Accordingly, in a particularly preferred variant of the invention the inorganic material is a compound of the following stoichiometry:

Li_{1+x+y}AlₓTi₂₋ₓSi_{y}P_{3-y}O₁₂*nGeO₂

where 0≤x≤1 and 0≤y≤1 and 0≤n≤1

A LAGTSP is for example obtainable from OHARA GmbH, Hofheim, Germany obtainable under the product name LICGC® AG01.

The lithium hydroxide is present in the rich working medium and is withdrawn with this from the second compartment. In order to be able to make use of it, it needs to be separated from the rich working medium. A separation apparatus is provided for this purpose. A preferred development of the invention accordingly includes the following additional process steps:
m) providing a separation apparatus;
n) separating the lithium hydroxide from the rich working medium with the aid of the separation apparatus.

After the lithium hydroxide has been separated from the rich working medium, the working medium can either be disposed of as wastewater or else preferably be reused as poor working medium. For this it is necessary to operate the separation apparatus such that the LiOH is not separated in its entirety, but is instead maintained above the specified minimum concentration cₘ₀ of 50 ppm LiOH. This allows the working medium to be recycled to the second compartment as poor working medium. This then results in recirculation of the working medium between the second compartment and the separation apparatus.

A preferred development of the invention accordingly includes the following additional process steps:
n) separating the lithium hydroxide from the rich working medium with the aid of the separation apparatus so as to afford the poor working medium,
   wherein the step
b) providing a poor working medium comprising water and lithium hydroxide dissolved therein, the concentration of lithium hydroxide in the poor working medium C_{M0}, based on the total weight of the poor working medium, being at least 50 ppm by weight;
   takes place with the aid of the separation apparatus.

In order for recirculation of the working medium between the separation apparatus and the second compartment to be possible, it makes sense for both apparatuses to be installed in the same location. The same location is to be understood as meaning an integrated production facility. The electrochemical cell and separation apparatus are consequently part of an integrated facility.

It is also conceivable for the separation apparatus to be situated away from the electrochemical cell, in a different location. In that case it is however necessary for the working medium to be transported between the cell and the separation apparatus. However, this makes very little sense from an energetic point of view.

It is preferable that at least the electrochemical cell is operated continuously. This means there is a constant through-flow between the two compartments. The first compartment has a continuous through-flow of intermediate, resulting in the generation of wastewater, whereas the second compartment has a through-flow of working medium, which flows in as poor working medium and flows out as rich working medium. This makes possible both a higher throughput and the continuous withdrawal of membrane-damaging constituents of the intermediate and working medium. Continuous operation can therefore be expected to achieve better membrane stability than in batchwise operation.

An important aspect of the process is that the production of hydrogen and lithium hydroxide take place simultaneously. This is made possible by the combined membrane electrolysis of the Li+ and electrochemical water splitting in basic media.

The electrical voltage applied to the electrochemical cell is in the simplest case constant over time (DC voltage). However, it has been found to be advantageous to vary the voltage periodically over time. This is brought about by an improvement in the service life of the membrane. One explanation for this could be that membrane-damaging ions are flushed away from the membrane during periods when the cell is switched off.

In a preferred development of the process, the electrical voltage drawn from the electrical voltage source changes periodically over time.

Preferably, the voltage changes in a waveform-like manner. The waveform can here be a sine, a square, a triangle or a sawtooth.

In the simplest case, the waveform is obtained by periodically changing the polarity of the voltage (alternating voltage).

More preferably, the voltage is however changed by periodically switching it on and off. When the voltage is switched on, a constant value is maintained. This gives rise to a square wave. In this case, pulsing of the voltage can also be said to occur. It has been found to be advantageous when the periods in which the voltage is switched on are longer than the periods in which it is switched off. Preferably, the periods when it is switched on are 3 to 7 times longer than the periods when it is switched off, preferably about 5 times as long.

Accordingly, in a preferred development of the process the waveform is square, that is to say formed from a first wave section in which the voltage is switched on at a constant value and, following on from the first wave section, a second wave section in which the voltage is switched off, where the length of the first wave section is λ₁, the length of the second wave section is λ₂ and the following relationship applies:

λ₁=φ*λ₂ where 3<φ<7.

With regard to the periodic change in the voltage, it should also be noted that the voltage does not necessarily have to change polarity like an AC voltage. Although it is conceivable to allow the voltage to oscillate with an amplitude about U=0, it is preferable to leave the polarity (i.e. the sign) of the voltage unchanged and to change only the magnitude of the voltage. Therefore, in a preferred development of the process the polarity of the electrical voltage is maintained.

The invention will now be elucidated in detail with reference to process flow diagrams. In the figures provided for this purpose:

FIG. 1: shows the functional principle of the simultaneous membrane electrolysis of Li⁺ and water electrolysis in the electrochemical cell with LiSICon membrane;

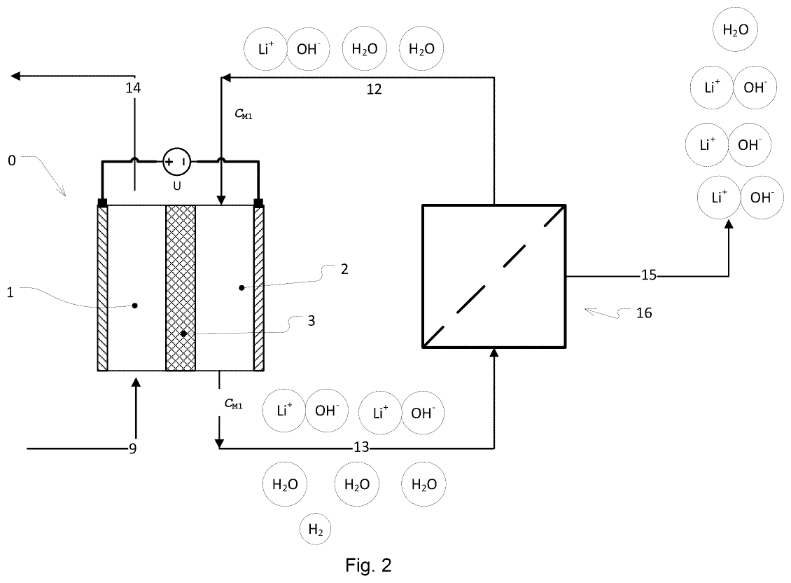

FIG. 2: shows the functional principle of the recirculation between the electrochemical cell and separation apparatus.

The electrochemical cell 0 necessary for the performance of the process is shown in FIG. 1. It includes a first compartment 1 and a second compartment 2. The two compartments 1 and 2 are separated from one another by a membrane 3. Arranged in the first compartment 1 is an anode 4. Arranged in the second compartment 2 is an cathode 5. The first compartment 1 can therefore be referred to as the anodic compartment and the second compartment 2 as the cathodic compartment.

A first electrical lead 6 connects the anode 4 with a voltage source 7. A second electrical lead 8 connects the cathode 5 with the voltage source 7. The chosen polarity of the voltage source 7 is such that the positive pole of the voltage source 7 is connected to the anode 4 and the negative pole of the voltage source 7 to the cathode 5. This polarity is always maintained, even if the magnitude of the electrical voltage U drawn from the voltage source 7 changes over time. In the simplest case, U is however constant over time.

An electric current/flows through the two electrical leads 6 and 8 and via the electrical voltage source 7. Since the membrane 3 acts as an electrical insulator, there is no electrical short circuit between the two electrodes 4 and 5 via the membrane 3.

The membrane 3 is a flat-sheet membrane that consists entirely of an LiSICon material. The anode 4 is a flat metal plate comprising titanium, niobium or tantalum. The cathode 5 is likewise a flat metal plate comprising titanium or nickel. In the simplest case, stainless steel plate is used as the cathode. Anode 4, cathode 5 and membrane 3 have the same shape and may be rectangular or circular. This is not apparent from the side view in FIG. 1. Instead of metal plates, it is also possible to use expanded metals, mesh or nets of the specified materials as electrodes.

The electrochemical cell 0 has an active area A that corresponds to the surface area of the membrane 3, anode 4 and cathode 5.

During operation, the first compartment 1 is charged with an intermediate 9. The intermediate 9 is an aqueous solution containing Li+ ions. From an electrochemical point of view, the intermediate 9 is regarded as the anolyte.

The intermediate 9 is obtained by mixing a feed 10 with a basic compound 11. The feed 10 may be an Li leach liquor from a natural deposit or a material stream arising from the reprocessing of used LIBs. The concentration of Li+ cations in the feed 10 (formula symbol c_{F}) should be at least 200 ppm by weight based on the total mass of the feed. Seawater has a lower Li concentration and must therefore first be concentrated before it is used in the process. The feed 10 also contains anions such as sulfate or chloride. The feed 10 also contains impurities. Anions and impurities are not shown in FIG. 1. The main component of the feed 10 is water H₂O. The pH of the feed is between 2 and 9.

The basic compound 11 is optimally calcium hydroxide Ca(OH)₂ (slaked lime). Metering the basic compound 11 into the feed 10 results in the formation of the intermediate 9. The purpose of adding the basic compound 11 to the feed 10 is to raise the pH into the alkaline range, more precisely to a pH of between 9 and 13. The electrochemical process in the cell is according to the invention carried out in basic media. The dosing of the basic compound 11 is accordingly chosen such that a pH of between 9 and 13 is achieved in the intermediate. The intermediate 9 is fed into the first compartment 1.

The second compartment is charged with a poor working medium 12. The poor working medium 12 is water H₂O having a low concentration C_{M0} of Li⁺ cations. The concentration c_{M0} is at least 50 ppm by weight based on the total mass of the poor working medium 12. From an electrochemical point of view, the poor working medium 12 is regarded as the catholyte.

The electrochemical cell 0 is also charged with an electrical voltage U drawn from a voltage source 7. This has the following effect:

Firstly, an electrolysis of water takes place in which water (H₂O) is split electrochemically into hydrogen (H₂) and oxygen (O₂). At the cathode 5, OH and hydrogen are formed. The OH-anions are however unable to cross the membrane 3 and combine with the Li⁺ cations present in the cathodic compartment 2 to form lithium hydroxide (LiOH). At the anode 4, oxygen and H⁺ are formed.

The formation of LiOH in the cathodic compartment 2 is maintained by the migration to the cathode 5 of Li+ cations from the intermediate 9 driven by the voltage U. They cross the membrane 3 by virtue of the Li conductivity of the membrane and accumulate in the working medium (membrane electrolysis). This results in the formation of a rich working medium 13, which is withdrawn from the second compartment 2. The concentration of Li+ ions in the rich working medium 13 is greater than in the poor working medium 12, thus c_{M1}>c_{M0}.

Thus, a water electrolysis, a membrane electrolysis of Lit and a synthesis of LiOH proceed simultaneously in the electrochemical cell 0.

The simultaneous operation of the Li+ membrane electrolysis and water electrolysis in the electrochemical cell thus results in the direct formation of lithium hydroxide LiOH and molecular hydrogen H₂. The LiOH is dissolved in the water, the hydrogen is dissolved in the water in part and is also present in gaseous form. The water containing the LiOH and the dissolved hydrogen is withdrawn from the cathodic compartment of the cell as rich working medium 13. Gaseous hydrogen is likewise withdrawn from the second compartment 2.

As a result of the membrane electrolysis the intermediate 9 becomes depleted in Li+, giving rise to wastewater 14. Thus, c_{W}<c_{F}. The formula symbol c_{W} here represents the concentration of Li ions in the wastewater 14 based on the total mass of the wastewater 14. The formula symbol C_{F} here represents the concentration of Li ions in the feed 10 based on the total mass of the feed 10.

FIG. 2 depicts how the LiOH is extracted as the target product 15 from the rich working medium 13.

For this purpose, a separation apparatus 16 is provided into which the rich working medium 13 is conveyed. The separation apparatus 16 separates from the rich working medium 13 the target product 15, which has a particularly high concentration of LiOH. The target product also contains water and impurities, depending on the desired specification of the target product.

The separation apparatus 16 can be a distillation column or a crystallizer.

The LiOH-depleted output stream from the separation apparatus 16 is recycled as poor working medium 12 to the second compartment 2 of the electrochemical cell 0.

As mentioned previously, the poor working medium 12 needs to have a certain LiOH concentration C_{M0} in order that the process in the electrochemical cell 0 can be initiated in the desired manner by virtue of the low initial resistance. The concentration c_{M0} should be at least 50 ppm by weight based on the total mass of the poor working medium 12. In order to ensure the desired concentration C_{M0}, the separation apparatus 16 is operated such that the not all the LiOH is separated from the rich working medium 13.

In addition to lithium hydroxide LiOH the process also generates H₂. The hydrogen H₂ is dissolved in the rich working medium 13 in part at least and is withdrawn together with the LiOH from the second compartment 2. Some of the hydrogen escapes in gaseous state from the second compartment 2.

Since the hydrogen H₂ is easily degassed from the water, it does not require much effort to remove it from the rich working medium. It is only if the hydrogen H₂ is to be utilized as a second target product that a corresponding second separation apparatus is provided with which the hydrogen is separately obtained in an appropriate quality/purity (not depicted).

The water H₂O, present in the rich working medium 13 is recycled as completely as possible as poor working medium 12. Only the water present in the target product 15 is lost from the process. This must be replenished in the poor working medium 12 as required (not depicted). The water in the intermediate 9 that originated from the feed does not end up being recirculated between the second compartment 2 and the separation apparatus 16, because the membrane 3 is impermeable to water.

### EXAMPLES

### Experimental Set-Up and Procedure

The following description aims to describe the influence of impurities in the form of foreign ions on ceramic lithium-conducting membranes during electrolysis. The effects of pH and voltage cycling are also described.

For the performance of the electrolysis, the electrolysis cell is first assembled and the anolyte and catholyte containers connected. Care is taken to ensure here that the inflow and return flow are in each case connected on the same side.

The anode and cathode used were in each case a round disc having a diameter of 19.5 mm and a thickness of 1 mm. The material was in each case a titanium expanded metal plate coated on both sides with IrTi mixed oxide, 12 g Ir/m2, 1 AF D 1.5 mm from Metakem GmbH, 61250 Usingen, Germany.

The membranes sampled were likewise circular discs about 25 mm in diameter. The thickness of the membranes was about 1 mm. The material of the membranes sampled is specified in the individual examples.

The electrolysis and the corresponding reservoir containers are blanketed with nitrogen for the entire duration of the process in order to prevent the formation of lithium carbonate. Each cell has a separate anolyte container and separate catholyte container. Each container is filled with about 1 kg of liquid; the exact mass is determined by reweighing. In all experiments the catholyte was always a 5 mmol/L LiOH solution (corresponding to 120 ppm by weight LiOH). The anolyte is in each case a lithium salt solution in various concentrations and with various lithium salts.

On switching on the pumps and applying the desired voltage, the experiment commences. The maximum flow rate is 900 mL/minute. Samples are collected every half hour or at longer intervals if this has been agreed. The first 3 mL of sample collected is discarded. For each sample collected, the power is in each case noted and the pH and conductivity of the sample determined. The samples are then returned to the appropriate container so as to keep the volume virtually constant.

At the end of the experiment, the containers are emptied and all leads and also the membrane are rinsed with demineralized water. The cells are dismantled, the membrane is photographed and SEM images of the catholyte side and anolyte side recorded to document any damage or changes to the membrane.

Some experiments with adjustment of the anolyte pH were carried out in order to confirm the hypothesis that a low pH has an adverse effect on membrane performance. Experiments with no pH adjustment gave very poor results. In experiments with pH adjustment, the pH of the anolyte solution is before the start of the experiment adjusted to the desired range by appropriate dosing with a basic compound. If this falls during the experiment, further base is metered in to maintain the pH. In contrast thereto are experiments in which the pH decreases during the electrolysis in line with the natural behaviour of the solutions.

In experiments with pulsing of the electrical voltage, the voltage supply is interrupted for a defined interval so that no voltage is applied to the electrochemical cell during this time. Over time, the voltage runs with a square waveform with no change in polarity. The purpose of this is to flush the membrane free of potentially interfering ions (H⁺) during the time with no voltage, which reduces damage to the membrane and boosts membrane performance.

The membrane performance is measured by the parameters permeability (g Li*mm/m²*h) and permeance (g Li/m²*h). The permeance indicates how much mass of lithium per unit membrane area and per unit time is being transported through the membrane. The permeability takes account also of the membrane thickness and thus makes it possible also to compare different membrane types having different thicknesses. For a comprehensive description of the performance both are required, since extremely thin membranes would permit enormously high permeance, but if concentration polarization effects were present in the membrane cell the permeabilities would give an inaccurate picture. Taking account of the membrane thickness would then no longer serve any useful purpose, since transport would not be limited by the membrane.

All measured values shown in the examples are subject to a measurement error of approx. ±10% attributable to imprecision in the positioning of the electrodes with respect to one another, in the determinations of the thickness of the membrane samples, and in the determination of the concentration via conductivity measurements.

All ceramics used originated from the manufacturers listed in Table 0 and can be ordered from these sources under the corresponding product names.

TABLE 0
Ceramics used and their manufacturers

| Manufacturer | Product name | Description | Stoichiometry |
|---|---|---|---|
| OHARA GmbH | LICGC ® PW01 | Ohara LiCGC ® | Li_{1.75}Al_{0.6}Ti_{1.4}Si_{0.15}P_{2.85}O₁₂ |
| | | PW01 powder | |
| OHARA GmbH | AG01 | Ohara LiCGC ® | Li₂O—Al₂O₃—SiO₂—P₂O₅—TiO₂—GeO₂ |
| | | AG01 ceramic | |
| OHARA GmbH | SP01 | Ohara LiCGC ® | Li₂O—Al₂O₃—SiO₂—P₂O₅—TiO₂ |
| | | SP01 ceramic | |
| Ampcera ™ (sold by | LISICON LAGP solid-state | Ampcera LAGP | Li_{1.5}Al_{0.5}Ge_{1.5}(PO₄)₃. |
| MSE Supplies) | electrolyte membrane for | ceramic | |
| | advanced lithium batteries, | | |
| | diameter d = 25.4 mm | | |
| Toshima Manufacturing | Li0.33La0.55TiO3 | Toshima LLTO | Li_{0.33}La_{0.55}TiO₃ |
| Co., Ltd. Materials | d25 × 0.8 mm | ceramic | |
| System Division | | | |

The lithium hydroxide used was analytical grade from Aldrich. All other substances used were technical grade.

Unless otherwise stated, LATSP membranes with a thickness of approx. 1 mm (LICGC®, Ohara) were used. The membrane discs were produced by an SPS sintering process at a pressure of 100*10⁵ Pa to 200*10⁵ Pa and a temperature of 950 °C or alternatively were obtained in the appropriate size for the measurement cells directly from various manufacturers (Ohara, Ampcera, Toshima).

### Description of the Sintering Process

### Sintering by FAST/SPS

The LATSP powder used is sintered by FAST/SPS (field-assisted sintering technology/spark plasma sintering). The sintering was carried out alongside a simultaneous rise in pressure and temperature so as to achieve high compaction and effective sintering in a very short sintering time. The sintering mould assembly consists of a graphite die having an outer diameter of 80 mm, an inner diameter of 36 mm and a height of 55 mm, two graphite half-shells having a wall thickness of 10 mm and the same height, and two graphite punches having a diameter of 25 mm and a height of 30 mm. The half-shells are placed in the die and one punch is introduced into the half-shells from below. Before weighing 2.5 g of the powder into the die onto the lower punch, graphite foil is placed on the punch for better contact. After having weighed in the powder, a second graphite foil is placed on the powder and the upper punch is introduced into the half shells. The die assembly is placed in the furnace chamber of the FAST/SPS furnace between two plates each made of carbon fibre-reinforced graphite. The assembly is contacted via the travel path of the electrodes and the desired pressure is built up. The die is in addition heated by an alternating current, which allows high temperatures to be reached in a short time. After a gradual temperature increase to 250 °C over five minutes, heating is continued at a rate of 130 °C/min until reaching a maximum temperature of 900 °C, which is held for a further five minutes. During the temperature increase, the pressure is also increased to 43 MPa for five minutes, this pressure likewise being held for five minutes. At the end of the hold time, the contact of the upper electrode is released from the die and the die cools down. The sintered membrane can then be removed from the mould.

### Example 1 (LATSP)

First of all, the voltage dependence of the ceramic membranes during the electrolysis was investigated. The electrolyses were each carried out with 0.1 mol/L LiOH and 1 mol/L LiOH at voltages of 3 V to 6 V. The results of the measurements are shown in Table 1.

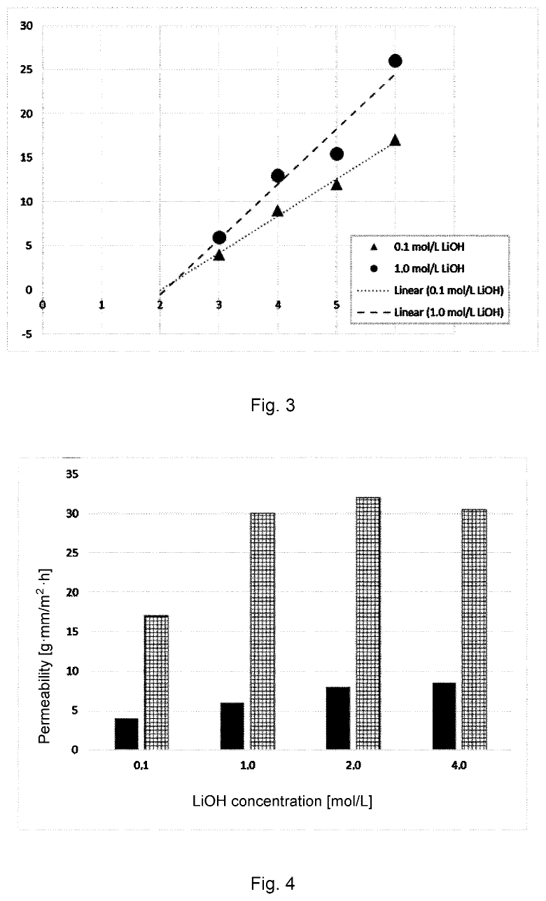

In graphical plots of the values, the linear relationship is clear. The point of intersection of the lines with the x axis at approx. 2 V derives from the decomposition voltage of the water and the internal resistances of the cell. This point of intersection is virtually identical for both concentrations. The plot is shown in FIG. 3.

TABLE 1
Voltage dependence of the electrolyses with ceramic membranes

| | |
|---|---|
| | Permeability |
| Voltage | (gLi*mm/m²*h) |

| [V] | 0.1 mol/L | 1 mol/L |
|---|---|---|
| 3 | 4 | 6 |
| 4 | 9 | 13 |
| 5 | 12 | 15.5 |
| 6 | 17 | 26 |

### Example 2 (LATSP)

It was also established that the membrane performance is independent of the anolyte concentration. For this, electrolyses were carried out at voltages of 3 V and 6 V, in each case with an initial charge of respectively 0.1, 1.0, 2.0 or 4.0 mol/L LiOH in the anolyte container.

The molar proportions of LiOH correspond to the following proportions by weight of Li:
0.1 mol/L=700 ppm Li=2400 ppm LiOH
1.0 mol/L=7000 ppm Li=24000 ppm LiOH
2.0 mol/L=14 000 ppm Li=48 000 ppm LiOH
4.0 mol/L=28 000 ppm Li=96 000 ppm LiOH

The results of the measurements are shown in Table 2. At concentrations of 1 mol/L to 4 mol/L there is no significant measured increase in membrane performance. An LiOH concentration of 0.1 mol/L achieves a slightly lower performance. FIG. 4 shows the results in graph form.

TABLE 2
No dependence on the anolyte concentration

| | |
|---|---|
| | Permeability |
| Anolyte concentration | (gLi*mm/m²*h) |

| [mol/L] | 3 V | 6 V |
|---|---|---|
| 0.1 | 4 | 17 |
| 1 | 6 | 30 |
| 2 | 8 | 32 |
| 4 | 8.5 | 30.5 |

### Example 3 (LATSP)

The electrolyses were carried out at 3 V, 4 V and 6 V, in each case with 0.1 mol/L lithium of the appropriate lithium salt in the recirculated anolyte. At the start of an experiment, after a short running time (shown in parentheses) the permeabilities are of a similar order of magnitude. In the case of lithium hydroxide and lithium carbonate the permeability is as expected increased by a higher voltage, whereas in the case of lithium chloride and lithium sulfate the permeability decreases after a longer running time at the higher voltages.

Determination of the pH at the end of each experiment showed that the pH values of the lithium chloride and lithium sulfate solutions had fallen to pH 3-4.

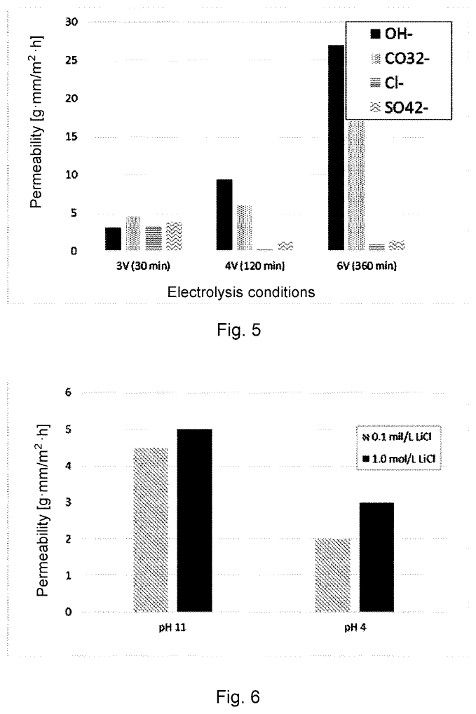

The measured values are shown in Table 3. FIG. 5 shows the results in graph form.

TABLE 3
Influence of anions on permeability

| | |
|---|---|
| Anion | (gLi*mm/m²*h) |

| permeability | 3 V (30 min) | 4 V (120 min) | 6 V (360 min) |
|---|---|---|---|
| OH⁻ | 3.1 | 9.4 | 27 |
| Cl⁻ | 3.2 | 0.3 | 0.9 |
| SO4²⁻ | 3.8 | 1.2 | 1.4 |
| CO3²⁻ | 4.5 | 6.0 | 17 |

### Example 4 (LATSP)

In order to examine more closely the influence of the pH of the recirculated anolyte on membrane performance during the electrolysis, a comparison using lithium chloride was carried out at a concentration of 0.1 mol/L and 1.0 mol/L, at a pH of 4 and 11 and at an electrolysis voltage of 3 V. The pH was adjusted with a few drops of a 1.0 mol/L lithium hydroxide solution. For both concentrations, raising the pH achieved an increase in permeability. In the electrolyses with LiCl solutions in which there was no pH adjustment with lithium hydroxide, the anolyte pH falls steadily, consequently the permeability in these measurements is subject to error when correlated with pH, since the latter could not be kept constant for long periods.

The results are reported in Table 4. FIG. 6 shows the results in graph form.

TABLE 4
Influence of pH on permeability//Adjustment with LiOH

| | |
|---|---|
| | Permeability |
| Concentration | (gLi*mm/m²*h) |

| [mol/L] | pH 11 | pH 4 |
|---|---|---|
| 0.1 | 4.5 | 2 |
| 1 | 5 | 3 |

### Example 5

The influence of the pH of the recirculated anolyte was tested in a 24-hour experiment using a 1.0 mol/L LiCl solution in which the voltage was increased.

A low pH and an increased voltage (3 to 8 V) did not result in permeabilities that remained stable. The pH varies according to running time until settling down at approx. pH 4 in the course of the experiment, which means that the permeability likewise does not achieve a constant value over the experiment time.

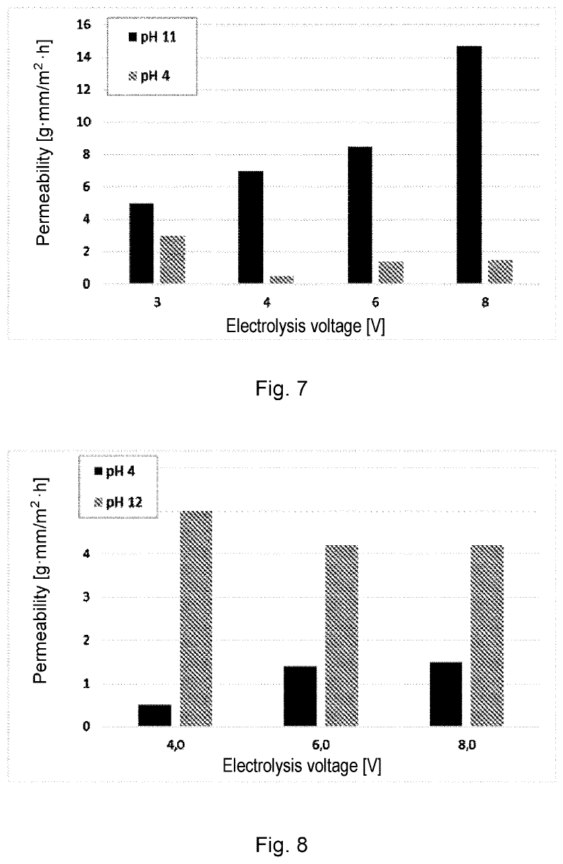

When the pH is adjusted by adding a little LiOH solution, the permeabilities stabilize at a high level. The results, which settle down after approx. 3 to 5 hours, are collated in Table 5. FIG. 7 shows the results in graph form.

TABLE 5
Dependence of permeability on pH and voltage

| | |
|---|---|
| | Permeability |
| Voltage | (gLi*mm/m²*h) |

| [V] | pH 11 | pH 4 |
|---|---|---|
| 3 | 5 | 3 |
| 4 | 7 | 0.5 |
| 6 | 8.5 | 1.4 |
| 8 | 14.7 | 1.5 |

### Example 6 (LATSP)

Since a pH adjustment with lithium hydroxide would not have been practicable, the pH of the recirculated anolyte was in this experiment adjusted with (Ca(OH)₂). The poor solubility of calcium hydroxide makes it difficult to meter in further amounts when the pH falls: The intermediate contained proportions of solid material and was slightly turbid. The experiment was carried out using a 0.1 mol/L lithium chloride solution that had been adjusted to pH 12 with Ca(OH)₂.

The pH adjustment with Ca(OH)₂ resulted in a clear increase in membrane permeability of more than 50%. The results are collated in Table 6. FIG. 8 shows the results in graph form.

TABLE 6
Influence of pH on permeability//Adjustment with Ca(OH)₂

| | |
|---|---|
| | Permeability |
| Voltage | (gLi*mm/m²*h) |

| [V] | pH 4 | pH 12 |
|---|---|---|
| 4 | 0.5 | 5 |
| 6 | 1.4 | 4.2 |
| 8 | 1.5 | 4.2 |

### Example 7 (LATSP)

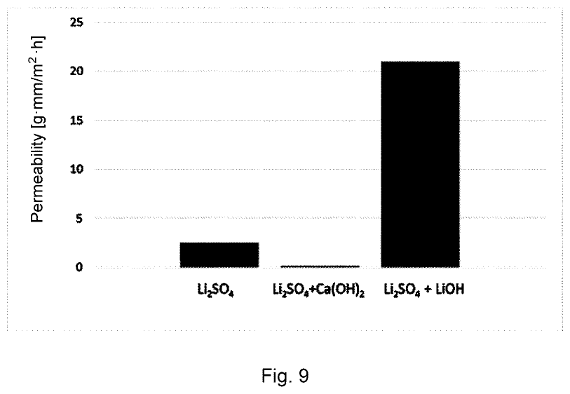

Likewise, when lithium sulfate Li₂SO₄ is the salt in the recirculated anolyte this is accompanied by a fall in pH during the electrolysis and damage to the membrane. Adjusting the pH with Ca(OH)₂ does not in this case lead to an improvement in membrane performance, since poorly soluble CaSO₄ forms, which precipitates on the membrane. Adjusting the pH with 1.0 mol/L LiOH solution does not lead to the formation of deposits on the membrane or to a sharp decrease in permeability, but instead improves them. The results are reported in Table 7. FIG. 9 shows the results in graph form.

TABLE 7
Influence of Li₂SO₄ on permeability

| | Voltage | | Permeability |
|---|---|---|---|
| Anolyte ingredients | [V] | pH | (gLi*mm/m²*h) |
| Li2SO4 | 6 | 2.7 | 2.6 |
| Li2SO4 + Ca(OH)2 | 6 | 12 | 0.2 |
| Li2SO4 + LiOH | 6 | 12 | 21 |

### Example 8 (LATSP)

Lithium carbonate as salt in the anolyte behaves differently to lithium chloride and lithium sulfate. At 4 V the membrane performance is a little lower than at 6 V. Between 8 V and 10 V the permeability fluctuates, reaching a stable level such that increasing the voltage does not result in an increase in permeability.

This is attributable to the limited solubility of lithium carbonate, which permits only a maximum concentration of approx. 0.15 mol/L. As already described in example 2, the permeability at lower lithium concentrations is lower. Moreover, increasing the pH through the addition of Ca(OH)₂ is possible only to a limited extent, because of the buffering effect of Li₂CO₃. Taken together, this is responsible for the different behaviour of Li₂CO₃ in the electrolysis experiment by comparison with LiCl and Li₂SO₄. The results are documented in Table 8.

TABLE 8
Influence on permeability of addition of Ca(OH)₂ when
using LiCl, Li₂SO₄ and Li₂CO₃ on permeability

| | Permeability | | |
|---|---|---|---|
| Voltage | [gLi*mm/m²*h] | | |
| [V] | LiCl | Li₂CO₃ | Li₂SO₄ |
| 4 | 6.1 | 2.1 | |
| 6 | 4.5 | 11 | 0.2 |
| 8 | 4.5 | 11.2 | |
| 10 | | 10.8 | 0.4 |

### Example 9 (LATSP)

In order to minimize the loss of permeability due to the added Ca(OH)₂ solution, experiments were carried out with additional pulsing of the voltage. Two different pulsing intervals were tested. With pulsing interval 1, the voltage is switched on for 10 seconds and then switched off for 2 seconds. This achieves a 25% increase in permeability.

With pulsing interval 2, the voltage is switched on for 50 seconds and switched off for 10 seconds and a 61% improvement in permeability is achieved.

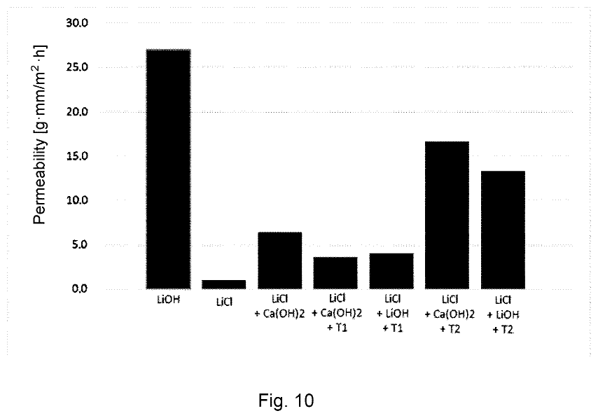

Table 9 compares a series of experiments with lithium chloride, each having a different permutation of pulsing intervals 1 and 2 and pH adjustment with LiOH and Ca(OH)₂. The reference for this is the comparison value for lithium hydroxide. The best performance here was achieved by lithium chloride with Ca(OH)₂ and pulsing interval 2. All experiments were run with 0.1 mol/L LiCl, 6 V and a crossflow velocity of 900 ml/min. The results are shown in Table 9 and presented in graph form in FIG. 10.

TABLE 9
Influence of pulsing the voltage, interaction
with addition of Ca(OH)₂

| | Permeability |
|---|---|
| Influencing factor | [g · mm/m² · h] |
| LiOH | 27.0 |
| LiCl | 1.0 |
| LiCl + Ca(OH)2 | 6.4 |
| LiCl + Ca(OH)2 + T1 | 3.6 |
| LiCl + LiOH + T1 | 4.0 |
| LiCl + Ca(OH)2 + T2 | 16.6 |
| LiCl + LiOH + T2 | 13.3 |

### Example 10 (Testing of Various LiSICon Materials)

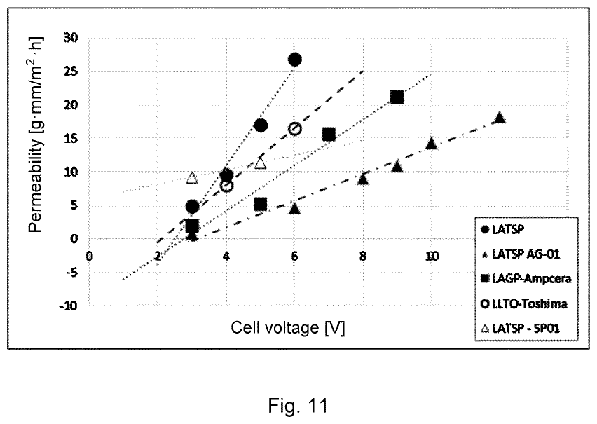

The various LiSICon materials in the electrochemical process for producing lithium hydroxide and hydrogen are described via the determination of permeability at various voltages for a basic 1.0 mol/L lithium hydroxide solution as anolyte. The results are shown in FIG. 11.

The properties of the materials can be deduced very well therefrom, but it should also be noted that a material having lower permeability can be used effectively in the process if the materials are processed into thin membranes.

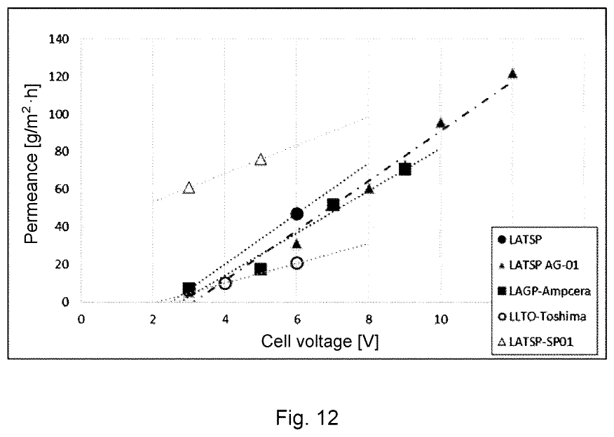

The investigated materials are listed in Table 0. In the keys for FIGS. 11 and 12, LATSP stands for LICGC® PW01, LATSP-AG-01 for LiCGC® AG01, LATSP-SP01 for LiCGC® SP-01 from Ohara. LAGP stands for the Ampcera material and LLTO for that of Toshima.

Alternatively, the behaviour of the different ceramics can also be described by the permeance in the respective case (FIG. 12). This representation is more suitable when mass transfer in the electrolysis cell is limited. The reason why LATSP SP01 differs in this representation from the other LiSICons investigated is possibly because this material, having a thickness of 0.15 mm, is very thin and consequently not as stable as the other materials investigated.

The measured values on which FIGS. 11 and 12 are based are shown in Table 13:

TABLE 13
Measured values for example 10

| Membrane | Voltage | Permeability | Permeance |
|---|---|---|---|
| material | [V] | [g · mm/m² · h] | [g/m² · h] |
| LATSP | 3.0 | 4.8 | 6.7 |
| LATSP | 4.0 | 9.6 | |
| LATSP | 5.0 | 17.0 | |
| LATSP | 6.0 | 26.8 | 47.0 |
| LAGP-Ampcera | 3.0 | 5.8 | |
| LAGP-Ampcera | 6.0 | 20.5 | |
| LAGP-Ampcera | 9.0 | 34.0 | |
| LAGP-Ampcera | 3.0 | 2.0 | 6.8 |
| LAGP-Ampcera | 5.0 | 5.2 | 17.4 |
| LAGP-Ampcera | 7.0 | 15.6 | 51.9 |
| LAGP-Ampcera | 9.0 | 21.2 | 70.5 |
| LATSP-AG-01 | 3.0 | 0.8 | 5.6 |
| LATSP-AG-01 | 6.0 | 4.7 | 31.2 |
| LATSP-AG-01 | 8.0 | 9.1 | 60.5 |
| LATSP-AG-01 | 9.0 | 10.9 | 72.8 |
| LATSP-AG-01 | 10.0 | 14.4 | 95.7 |
| LATSP-AG-01 | 12.0 | 18.3 | 122.0 |
| LLTO-Toshima | 4.0 | 8.0 | 10.0 |
| LLTO-Toshima | 6.0 | 16.5 | 20.6 |
| LATSP-SP01 | 3.0 | 9.2 | 61.0 |
| LATSP-SP01 | 5.0 | 11.4 | 76.0 |

### Example 11 (LAGP)

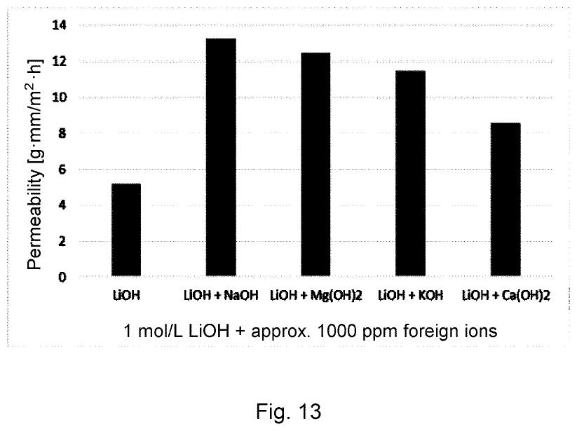

A basic anolyte solution was adulterated with approx. 1000 ppm (g/g) each of the following cations: sodium; potassium; magnesium; calcium. A LAGP membrane from Ampcera was used to transport the lithium from the solution into the catholyte with the permeabilities collated in FIG. 13. Analysis by ion-exchange chromatography showed that all catholytes (purified LiOH) contained less than 10 ppm of the corresponding impurities. Pulsing of the 5 V voltage as described in example 9, pulsing interval T2, was employed in each run.

### Example 12 (LATSP)

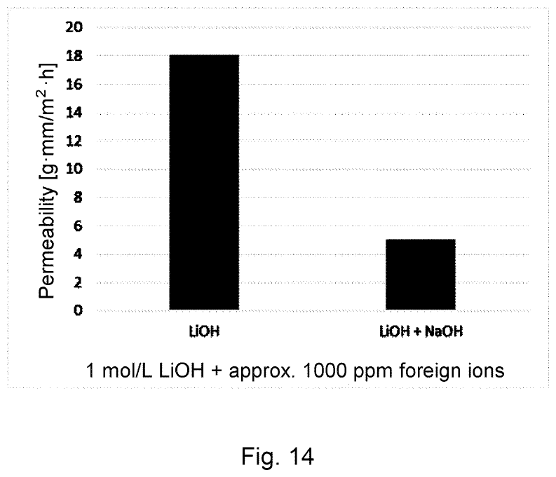

A basic anolyte solution was adulterated with approx. 1000 ppm of sodium ions. An LATSP membrane (LICGC PW01, Ohara, sintered as described above) was used to enrich the catholyte with the lithium from the solution with the permeability shown in FIG. 14. The permeability in the absence of Na is shown as a comparison. The cell voltage was 5 V, pulsed with pulsing interval T2, as described in example 9. Analysis by ion-exchange chromatography showed that the purified LiOH contained less than 10 ppm of sodium ions.

### Ion-Chromatography Analysis

In examples 11 and 12 the contents of Li and Na ions in the analyte and catholyte was determined by ion-exchange chromatography (IEC) as follows:

The samples were filtered before the measurement with the aid of a syringe filter (type Chromafil®Xtra MV-20/25, pore size 0.20 μm, for aqueous and polar media).

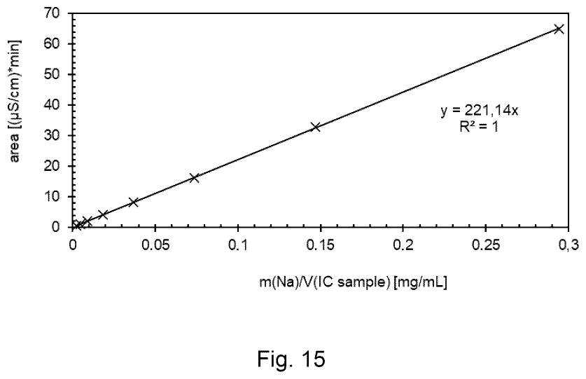

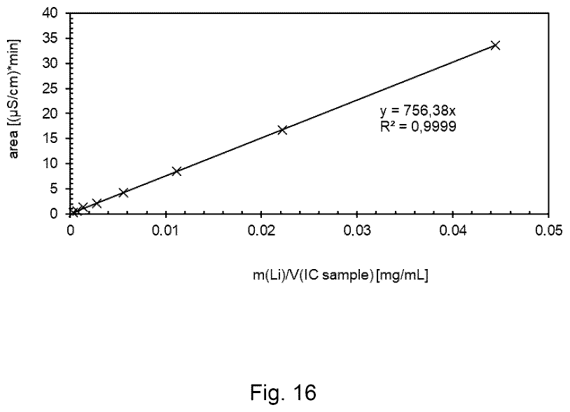

Before the investigation, the IEC instrument (Metrohm IC 930 Compact, C Supp C6 250/4.0, standard (1.7 mM HNO₃, 1.7 mM dipicolinic acid), conductivity sensor) was referenced and externally calibrated for Li and Na. The calibration lines used are shown in FIGS. 15 (for Na) and 16 (for Li).

### CONCLUSION

The experiments show that the permeability of the membranes investigated is made poorer by the presence of lithium sulfate, lithium chloride and lithium carbonate. The harmful effect can however be sent into reverse by the addition of hydroxides, such as Ca(OH)₂ but also by LiOH, especially when the electrical voltage is pulsed. A high permeability is a prerequisite for high process efficiency. The measures discovered therefore help the process to run more efficiently.

### LIST OF REFERENCE SYMBOLS

0 Electrochemical cell
1 First compartment
2 Second compartment
3 Membrane
4 Anode
5 Cathode
6 First electrical lead
7 Voltage source
8 Second electrical lead
9 Intermediate
10 Feed
11 Basic compound
12 Poor working medium
13 Rich working medium
14 Wastewater
15 Target product
16 Separation apparatus
H₂O Water
H₂ Hydrogen
O₂ Oxygen
LiOH Lithium hydroxide
OH⁻ OH anions
Li⁺ Lithium cations
U Electrical voltage
I Electric current
A Active area
C_{F} LiOH concentration in feed
C_{W} LiOH concentration in wastewater
C_{M0} LiOH concentration in poor working medium
C_{M1} LiOH concentration in rich working medium

1. Process for producing hydrogen and lithium hydroxide, comprising the following steps:
a) providing a feed comprising at least water, Li cations, anions, and also impurities, the concentration of Li cations in the feed C_{F} being at least 200 ppm by weight or between 500 ppm by weight and 140 000 ppm by weight, in each case based on the total weight of the feed, the pH of the feed measured at 25 °C using a glass electrode being between 2 and 9;
b) providing a poor working medium comprising water and lithium hydroxide dissolved therein, the concentration of lithium hydroxide in the poor working medium C_{M0}, based on the total weight of the poor working medium, being at least 50 ppm by weight;
c) providing a basic compound;
d) providing at least one electrochemical cell, wherein the electrochemical cell has the following properties:
i. the electrochemical cell includes a first compartment in which an anode is arranged;
ii. the electrochemical cell includes a second compartment in which a cathode is arranged;
iii. the electrochemical cell includes a membrane that separates the first membrane from the second membrane, the membrane having the area A;
iv. the membrane comprises an inorganic material that possesses conductivity for Li ions and that is electrically insulating;
e) providing at least one electrical voltage source that is connected to the anode via a first electrical lead and to the cathode via a second electrical lead;
f) metering the basic compound into the feed such that an intermediate is obtained, the pH of the intermediate measured at 25 °C using a glass electrode being between 9 and 13;
g) charging of the first compartment with the intermediate;
h) charging of the second compartment with the poor working medium;
i) charging of the electrochemical cell with an electrical voltage U drawn from the electrical voltage source such that an electrical current/flows between the anode and cathode, the ratio Q of the current strength of the electrical current/and the area A of the membrane being between 100 A/m² and 500 A/m² or between 150 A/m² and 350 A/m²;
j) withdrawing from the first compartment of wastewater comprising at least water, Li salts dissolved therein, oxygen and also impurities, the concentration of Li ions in the wastewater C_{W}, based on the total weight of the wastewater, being lower than the concentration of Li ions in the feed C_{F};
k) withdrawing from the second compartment of a rich working medium comprising water and lithium hydroxide and also hydrogen, the concentration of lithium hydroxide in the rich working medium C_{M1}, based on the total weight of the rich working medium, being greater than the concentration of lithium hydroxide in the poor working medium C_{M0}.

2. Process according to claim 1, wherein the basic compound is selected from the group consisting of Ca(OH)₂, KOH, NaOH, LiOH and NH₄OH.

3. Process according to claim 2, wherein the basic compound is Ca(OH)₂.

4. Process according to claim 1 wherein the pH of the intermediate, measured using a glass electrode at 25 °C, is between 9 and 12.

5. Process according to claim 1, wherein the anions present in the feed are selected from the group consisting of sulfate, carbonate, hydroxide, chloride and fluoride.

6. Process according to claim 1 wherein the feed contains impurities in the form of compounds of elements selected from the group consisting of B, Na, Mg, Al, Si, K, Ca, Mn, Fe, Co, Ni, Cu and C.

7. Process according to claim 1, wherein the inorganic material present in the membrane possesses a specific conductivity for Li ions σ, measured by the “impedance spectroscopy” method described herein, that at a temperature of 23 °C is at least 1*10⁻⁵ S/m or at least 5*10⁻⁵ S/m or at least 10*10⁻⁵ S/m and not more than 100*10⁻⁵ S/m.

8. Process according to claim 7, wherein the inorganic material is a compound of the following stoichiometry (LATP):
Li₁₊ₓAlₓTi₂₋ₓ(PO₄)₃
where 0.1≤x≤0.3, where preferably x=0.3.

9. Process according to claim 7, wherein the inorganic material is a compound of the following stoichiometry (LATSP):
Li_{1+x+y}AlₓTi₂₋ₓSi_{y}P_{3-y}O₁₂
where 0.1≤x≤0.3 and 0.2≤y≤0.4.

10. Process according to claim 7, wherein the inorganic material is a compound of the following stoichiometry (LAGTSP):
Li_{1+x+y}AlₓTi₂₋ₓSi_{y}P_{3-y}O₁₂*nGeO₂
where 0≤x≤1 and 0≤y≤1 and 0≤n≤1

11. Process according to claim 7, wherein the inorganic material is a compound of the following stoichiometry (LAGTP):
Li_{1.4}Al_{0.4}(Ge₁₋ₓTiₓ)_{1.6}(PO₄)₃
where 0≤x≤1.

12. Process according to claim 7, wherein the inorganic material is a compound of the following stoichiometry (LAGP):
Li₁₊ₓAlₓGe₂₋ₓ(PO₄)₃
where: x=0 or x=0.2 or x=0.4.

13. Process according to claim 7, wherein the inorganic material is a compound of the following stoichiometry (LLTO):
Li₃ₓLa_{(2/3)-x□(1/3)-2x}TiO₃
where 0≤x≤0.16.

14. Process according to claim 1, comprising the additional steps of:
m) providing a separation apparatus;
n) separating the lithium hydroxide from the rich working medium with the aid of the separation apparatus.

15. Process according to claim 14, wherein the step
n) separating the lithium hydroxide from the rich working medium with the aid of the separation apparatus;
affords the poor working medium,
such that the step
b) providing a poor working medium comprising water and lithium hydroxide dissolved therein, the concentration of lithium hydroxide in the poor working medium C_{M0}, based on the total weight of the poor working medium, being at least 50 ppm by weight;
takes place with the aid of the separation apparatus.

16. Process according to claim 14, wherein the electrochemical cell and the separation apparatus are provided in the same location.

17. Process according to claim 1, wherein at least the electrochemical cell is operated continuously.

18. Process according to claim 1, wherein the production of hydrogen and lithium hydroxide take place simultaneously.

19. Process according to claim 1, wherein the electrical voltage drawn from the electrical voltage source changes periodically over time.

20. Process according to claim 19, wherein the electrical voltage drawn from the electrical voltage source changes over time in a waveform-like manner, the waveform being selected from the group consisting of the following waveforms: sine, square, triangle or sawtooth.

21. Process according to claim 20, wherein the waveform is square, that is to say formed from a first wave section in which the voltage is switched on at a constant value and, following on from the first wave section, a second wave section in which the voltage is switched off, where the length of the first wave section is λ₁, the length of the second wave section is λ₂ and the following relationship applies: λ₁=φ*λ₂ where 3<φ<7.

22. Process according to claim 19, wherein the polarity of the electrical voltage is maintained.

23. Process according to claim 1, wherein the prevailing pH in both the first compartment and the second compartment, measured at 25 °C with a glass electrode, is between 9 and 13.
